(19) United States
(12) Patent Application Publication
(10) Pub. No.: US 2018/0084506 A1
(43) Pub. Date: Mar. 22, 2018

(54) METHODS OF MULTI-USER TRANSMIT POWER CONTROL AND MCS SELECTION FOR FULL DUPLEX OFDMA 802.11

(71) Applicant: INTEL CORPORATION, Santa Clara, CA (US)

(72) Inventors: Alexander W. MIN, Portland, OR (US); Minyoung PARK, Portland, OR (US)

(21) Appl. No.: 15/273,210

(22) Filed: Sep. 22, 2016

(51) Int. Cl. H04W 52/24; H04L 5/14

(52) U.S. Cl. CPC H04W 52/243; H04L 5/14

(57) ABSTRACT

One exemplary embodiment exploits the non-uniformity of the interference at the downlink STA to maximize the full-duplex MU UL OFDMA transmission throughput performance. A first exemplary technology adjusts the transmit power of the uplink STAs so that the interference caused at the downlink STA is uniform (or substantially uniform) across OFDMA sub-channels. By doing so, the AP can optimize uplink transmission performance (e.g., aggregate link throughput) without degrading downlink transmission performance (e.g., in terms of the MCS used). A second exemplary technology uses OFDMA transmission for downlink, even if there is only one downlink STA, and adjusts the MCS for each downlink sub-channel based on the interference caused by UL STAs on each sub-channel. This allows the DL throughput to be maximized (and higher than a single 20 MHz OFDM transmission).

### TECHNICAL FIELD

An exemplary aspect is directed toward communications systems. More specifically an exemplary aspect is directed toward wireless communications systems and even more specifically to IEEE (Institute of Electrical and Electronics Engineers) 802.11 wireless communications systems. Even more specifically, exemplary aspects are at least directed toward one or more of IEEE (Institute of Electrical and Electronics Engineers) 802.11ax communications systems and in general any wireless communications system or protocol, such as 4G, 4G LTE, 5G and later, and the like.

### BACKGROUND

Wireless networks transmit and receive information utilizing varying techniques and protocols. For example, but not by way of limitation, two common and widely adopted techniques used for communication are those that adhere to the Institute for Electronic and Electrical Engineers (IEEE) 802.11 standards such as the IEEE 802.11n standard, the IEEE 802.11ac standard and the IEEE 802.11ax standard.

The IEEE 802.11 standards specify a common Medium Access Control (MAC) Layer which provides a variety of functions that support the operation of IEEE 802.11-based Wireless LANs (WLANs) and devices. The MAC Layer manages and maintains communications between IEEE 802.11 stations (such as between radio network interface cards (NIC) in a PC or other wireless device(s) or stations (STA) and access points (APs)) by coordinating access to a shared radio channel and utilizing protocols that enhance communications over a wireless medium.

IEEE 802.11ax is the successor to 802.11ac and is proposed to increase the efficiency of WLAN networks, especially in high density areas like public hotspots and other dense traffic areas. IEEE 802.11ax also uses orthogonal frequency-division multiple access (OFDMA), and related to IEEE 802.11ax, the High Efficiency WLAN Study Group (HEW SG) within the IEEE 802.11 working group is considering improvements to spectrum efficiency to enhance system throughput/area in high density scenarios of APs (Access Points) and/or STAs (Stations).

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates full-duplex communication with OFDMA-aggregated uplink and downlink transmissions;

FIG. 2 illustrates downlink and uplink frame transmissions between the AP and STAs from time=0;

FIG. 3 illustrates inter-node interference (i.e., between uplink STAs A/B/C and downlink STA D) in full-duplex OFDMA Wi-Fi systems;

FIG. 4 illustrates non-uniform interference on OFDMA sub-channels in full-duplex OFDMA transmission scenarios, where a total of nine STAs transmit uplink frames on nine different 2 MHz (or 26 tones) OFDMA sub-channels;

FIG. 5 illustrates one proposed transmission power control mechanism;

FIG. 6 illustrates one proposed MCS optimization or improvement for downlink OFDMA transmissions;

FIG. 7 shows an exemplary throughput performance comparison between: (i) half-duplex (downlink only), (ii) full-duplex w/o proposed TPC for UL STAs, (iii) full-duplex w/proposed TPC for UL STAs, and (iv) full-duplex w/ proposed MCS optimization for DL STA;

FIGS. 8-9 show the distribution of DL MCS as a function of the AP-STA separation;

FIG. 10 compares the throughput performance of four transmission modes depending on the level of separation between the AP and DL STA;

FIGS. 11-13 show the distribution of STAs that are eligible for UL OFDMA frame transmission without causing interference to the reception of DL frames from an AP to the DL STA (seen as the red square);

FIG. 14 shows a full-duplex throughput performance comparison between the UL transmit power control and the DL MCS selection. FIG. 14 shows that DL optimization is more suitable when the DL STA is located far from the AP and vice versa;

FIG. 15 illustrates how one exemplary adaptive optimization scheme (“Proposed”) outperforms the fixed UL and DL optimizations;

FIG. 16 illustrates an exemplary wireless device/circuit configuration;

FIG. 17 is a flowchart illustrating an exemplary method for adjusting transmit power;

FIG. 18 is a flowchart illustrating an exemplary method for adjusting downlink stations modulation and coding schemes; and

FIG. 19 is a flowchart illustrating options for full-duplex simultaneous uplink and downlink transmissions.

### DESCRIPTION OF EMBODIMENTS

Full-duplex communication can potentially double throughput performance by enabling simultaneous transmit and receive (Tx and Rx, respectively) operations on the same frequency band using self-interference cancellation (SIC) technologies. SIC can be accomplished using analog RF circuitry and digital signal processing, as one example. With the recent advance in SIC technologies, it is now feasible to enable full-duplex capability on Wi-Fi AP (Access Point) platforms, making full-duplex a strong candidate technology for next-generation Wi-Fi systems beyond IEEE 802.11ax.

The Draft IEEE 802.11ax specification defines multi-user (MU) uplink (UL) and downlink (DL) OFDMA (Orthogonal Frequency Division Multiple Access) as allowing multiple stations (STAs) to simultaneously transmit data to (or receive data from) Wi-Fi access points (AP).

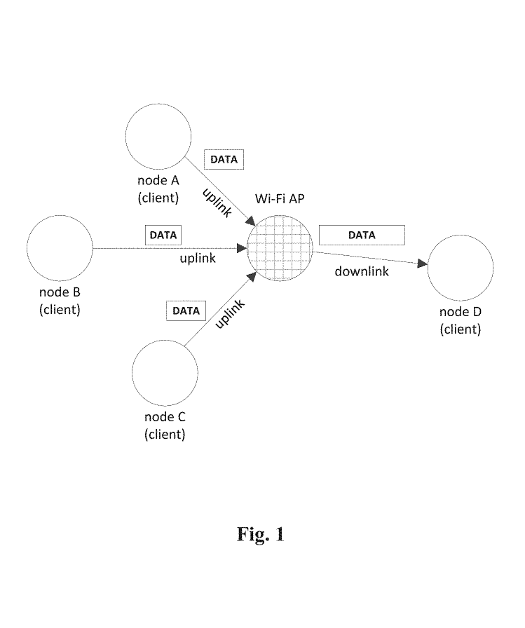

One method is to aggregate multiple UL OFDMA transmissions with small frames, while the AP transmits a larger frame to a downlink STA (Station), as shown in FIG. 1. The AP can successfully decode uplink frame transmissions by cancelling self-interference (i.e., from the Tx chain to the Rx chain) thanks to the SIC capability.

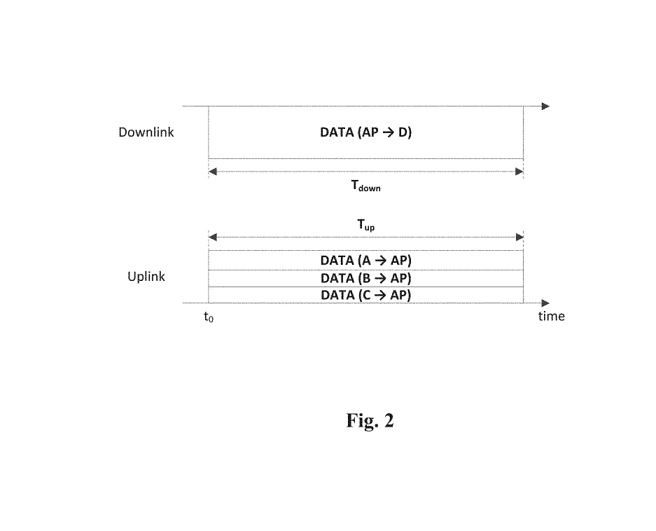

Specifically, FIG. 1 illustrates a full-duplex communication OFDMA Wi-Fi system with OFDMA-aggregated uplink and downlink transmissions as shown in FIG. 2. FIG. 1 includes a plurality of Nodes (A-C, or clients), a Wi-Fi AP and Node D. Nodes A-C are sending uplink frame transmissions to the AP, while Node D is receiving a downlink frame transmission from the AP. In FIG. 2, the uplink and downlink frames for the respective nodes are shown from time=0.

In full-duplex OFDMA communications, multiple STAs can transmit frames to the AP on different OFDMA sub-channels (a.k.a. Resource Units or RUs) while the AP is transmitting a downlink frame to another STA (e.g., node D in FIG. 2). However, the frame transmissions from uplink STAs (selected by the AP) may cause different amounts of interference at the downlink STA on different sub-channels depending on the uplink STAs transmit power level, relative location from the downlink STA, condition of operating sub-channels on links between STAs, and/or the like.

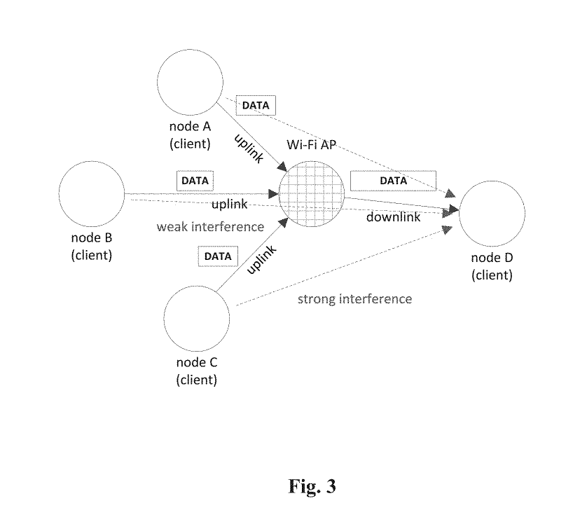

Therefore, the downlink STA may experience different SINR (Signal to Interference-plus-Noise Ratio) on different OFDMA sub-channels, as shown in FIG. 3. As a result, the AP should configure downlink transmission parameters (e.g., MCS) based on the worst case interference scenario, e.g., the inter-node interference level on RU4 in FIG. 3.

More specifically, FIG. 3 illustrates an exemplary scenario where there is weak interference caused between Node B and Node D, and strong interference present between Node C and Node D. Interference may also exist between Node A and Node D.

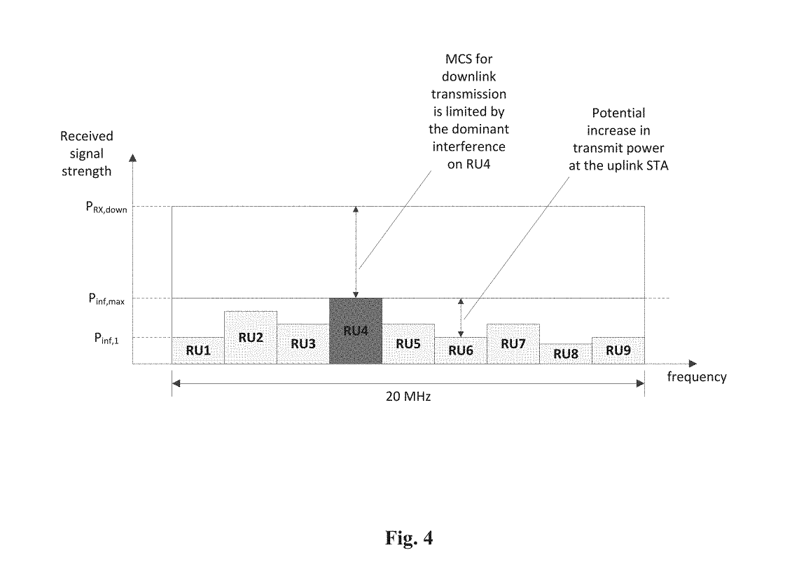

In such a non-uniform, sub-channel-dependent interference scenario, the downlink STA may be able to tolerate additional interference on certain sub-channels, e.g., all the sub-channels except RU4, as shown in FIG. 4. The AP can allocate different transmit power to UL STAs operating on different OFDMA sub-channels, as specified in the IEEE 802.11ax draft specification (“OFDMA and SU tone allocation”):

Subchannelization defines subchannels that can be allocated to stations depending on their channel conditions and service requirements. Using subchannelization, an OFDMA system can potentially allocate different transmit power to different allocations.

One exemplary embodiment exploits the non-uniformity of the interference at the downlink STA to maximize the full-duplex MU UL OFDMA transmission throughput performance.

Simulation-based performance evaluation results show that the exemplary inter-STA-interference-aware full-duplex schemes are capable of at least achieving an ˜24% and an ˜18% increase in UL and DL throughput performance, respectively.

One exemplary embodiment further optionally enables enhanced transmit power control for uplink STAs in full-duplex OFDMA communication scenarios.

A first exemplary technology adjusts the transmit power of the uplink STAs so that the interference caused at the downlink STA is uniform (or substantially uniform) across OFDMA sub-channels. By doing so, the AP can optimize or improve uplink transmission performance (e.g., aggregate link throughput) without degrading downlink transmission performance (e.g., in terms of the MCS used).

A second exemplary technology uses OFDMA transmission for downlink, even if there is only one downlink STA, and adjusts the MCS for each downlink sub-channel based on the interference caused by UL STAs on each sub-channel. This allows the DL throughput to be maximized (and higher than a single 20 MHz OFDM transmission).

Non-uniform interference levels on different sub-channels caused by the transmissions from multiple UL STAs, as shown in FIG. 4, is one of the unique challenges in full-duplex OFDMA Wi-Fi communication scenarios. An exemplary embodiment exploits such non-uniform interference across OFDMA sub-channels to, for example, (i) optimize or improve MU UL transmit power levels and (ii) optimize or improve the MCS (Modulation and Coding Scheme) on each DL sub-channel, in order to improve or maximize throughput performance.

Exemplary AP Behavior

The exemplary behavior of the AP for the above-described non-uniform sub-channel interference in full-duplex OFDMA communication scenarios is as follows. Note that it was assumed that the AP has inter-node interference information and it is known how to measure and collect inter-node interference. It was also assumed that each UL STA uses a single OFDMA sub-channel for simplicity; however, the proposed method/technology can be easily extended to the cases where a UL STA employs multiple sub-channels.

Adjusting Uplink STAs' Transmit Power

Upon the identification of full-duplex opportunity and selection of downlink and uplink STAs for full-duplex OFDMA, the AP performs the following functions:
The downlink STA estimates the received signal strength on each OFDMA sub-channel (or RU) n, denoted as P_{inf,n}, caused by the frame transmissions from UL STAs and reports this information to the AP
The AP identifies the maximum interference power, P_{inf,max}, that the downlink STA can tolerate to use an MCS that is the same as (or similar to) the MCS that the downlink STA was using in the half-duplex mode (i.e., in the absence of interference from uplink transmissions)
For each sub-channel n, the AP determines the amount of transmit power P_{Δinf,n} that needs to be adjusted (increased/decreased) in dB at the corresponding UL STA without exceeding the maximum interference power P_{inf,max},

P_{Δinf,n}=P_{inf,max}−P_{inf,n} Eq (1)
The AP sends a Full-Duplex Trigger frame to the scheduled UL and DL STAs

The Full-Duplex Trigger frame includes the amount of transmit power P_{Δinf,n} that should be adjusted for each UL STA calculated in Eq. (1)
If needed, the AP further adjusts the transmit power level for the UL STAs, e.g., the AP may need to ensure that the received signal strength on OFDMA sub-channels at the AP fall within a certain range
The AP transmits the DL frame while receiving UL OFDMA frame transmissions from the UL STAs

Adjusting Downlink STA's MCS Per Sub-Channels

Instead of adjusting transmit power of uplink STAs, the downlink STA may use different MCSs on different sub-channels based on the SINR of each sub-channel. For example:
The downlink STA estimates the received signal strength on each OFDMA sub-channel (or RU) n, denoted as P_{in,n}, caused by the frame transmissions from UL STAs and reports this information to the AP
The AP calculates an MCS (MCSn) for each sub-channel that can be used in the presence of the interference P_{inf,n}
The AP sends a Full-Duplex Trigger frame to the scheduled UL and DL STAs
The AP transmits the DL frame while receiving UL OFDMA frame transmissions from the UL STAs

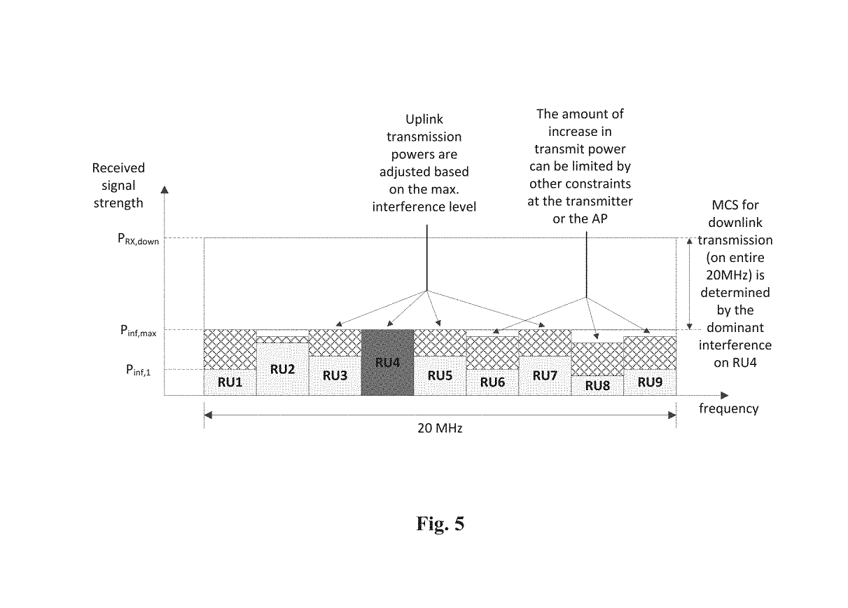

FIG. 5 provides an illustration of the proposed transmission power control mechanism for uplink OFDMA transmissions. The AP opportunistically increases the transmission power level of uplink STAs while maintaining their received signal strength at the downlink STA below a certain threshold.

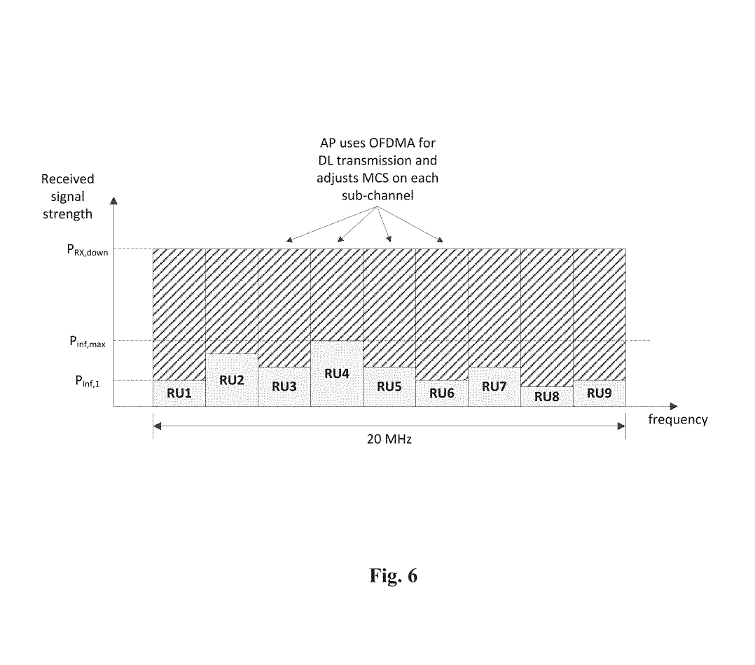

FIG. 6 provides an illustration of the proposed MCS optimization or improvement for downlink OFDMA transmissions. Here, the AP adjusts the MCS on each sub-channel based on interference caused by the uplink STAs.

Performance Evaluation Results

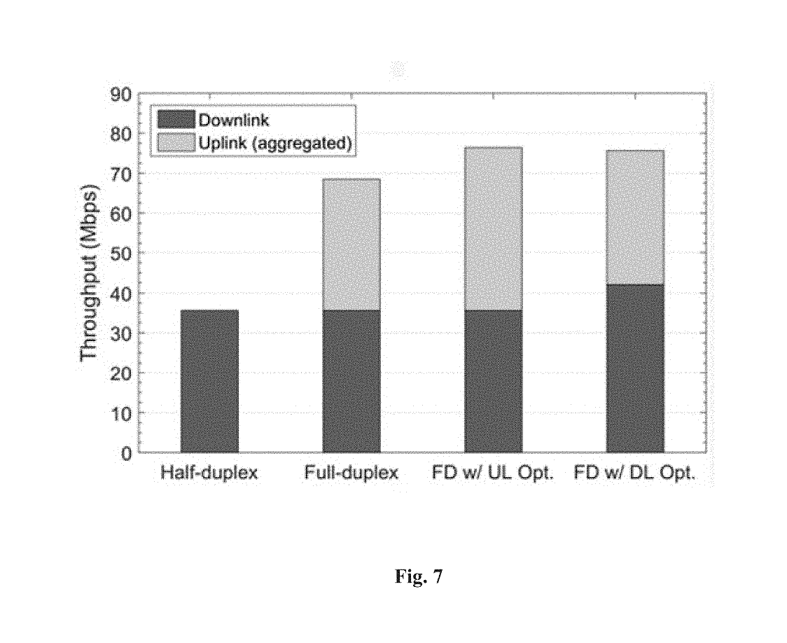

FIG. 7 compares the throughput performance of three tested techniques: (i) Half-duplex (i.e., downlink transmission only), (ii) Full-duplex, (iii) Full-duplex with Transmit Power Control (TPC) for UL STAs (by adjusting the uplink STAs' transmit power), and (iv) Full-duplex with MCS optimization for DL STA (using the adjusted downlink STA's MCS per sub-channels).

There are three main observations.

First, FIG. 7 shows that the proposed Full-duplex schemes, i.e., (ii), (iii), and (iv), achieve higher throughput performance than Half-duplex (i.e., downlink only) by enabling simultaneous UL and DL transmissions. Note that, the DL throughput performance does not degrade because the AP selects the UL STA and configures the UL STA transmit configurations in such a way that UL transmissions do not affect the downlink throughput performance.

Second, Full-duplex with TPC achieves ˜24% better UL throughput performance than the Full-duplex without TPC thanks to the AP's ability to exploit the non-uniformity of interference at the downlink STA, and ability to adjust UL transmit power level accordingly. Note that DL performance is almost identical because the UL TPC is performed in such a way that the increase in UL transmit power does not degrade the signal to Interference-plus-Noise Ratio (SINR) at the downlink STA.

Third, Full-duplex with DL MCS optimization achieves ˜18% better DL throughput performance than the Full-duplex without MCS due to AP's ability to optimize MCS per sub-channel, thus fully exploiting the non-uniform interference caused by the UL transmissions at the downlink STA.

The techniques therefore clearly provide better wireless services by at least improving throughput performance and spectrum efficiency for next generation wireless and/or Wi-Fi systems.

An optional embodiment addresses one problem of when to optimize UL transmit power parameters rather than the DL MCS, and vice versa. Ideally, the AP should adaptively employ an optimization strategy (i.e., UL optimization vs. DL optimization) so that the overall full-duplex throughput performance can be maximized.

One exemplary technique adaptively employs a UL or DL optimization strategy so that the total full-duplex throughput performance (i.e., UL plus DL OFDMA transmissions) can be improved or maximized.

In accordance with this exemplary technique, an AP is enabled to adaptively employ either UL OFDMA transmit power control (TPC) or DL OFDMA MCS optimization in such a way that the sum of UL and DL throughput performance can be maximized.

Particular scenarios/environments were identified under which UL OFDMA transmit power control outperforms the DL OFDMA MCS optimization approach, and vice versa. Based on the insights provided by the simulation study, one exemplary technique uses a DL transmission configuration (e.g., received signal strength, MCS, etc.) as a hint in deciding the optimization approach.

This exemplary technique addresses how to select a better optimization approach to maximize the overall full-duplex throughput performance.

Comparison of UL vs. DL Optimization Approaches

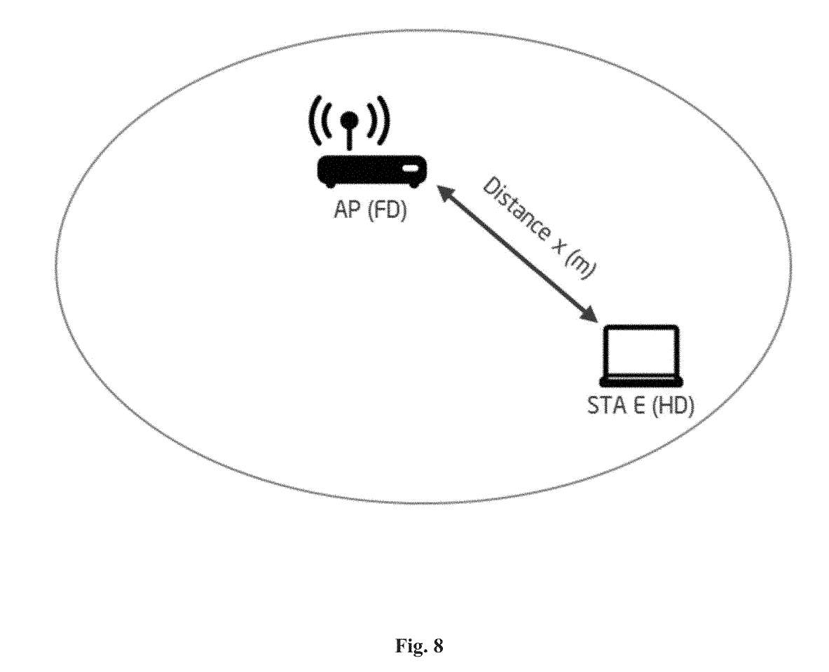

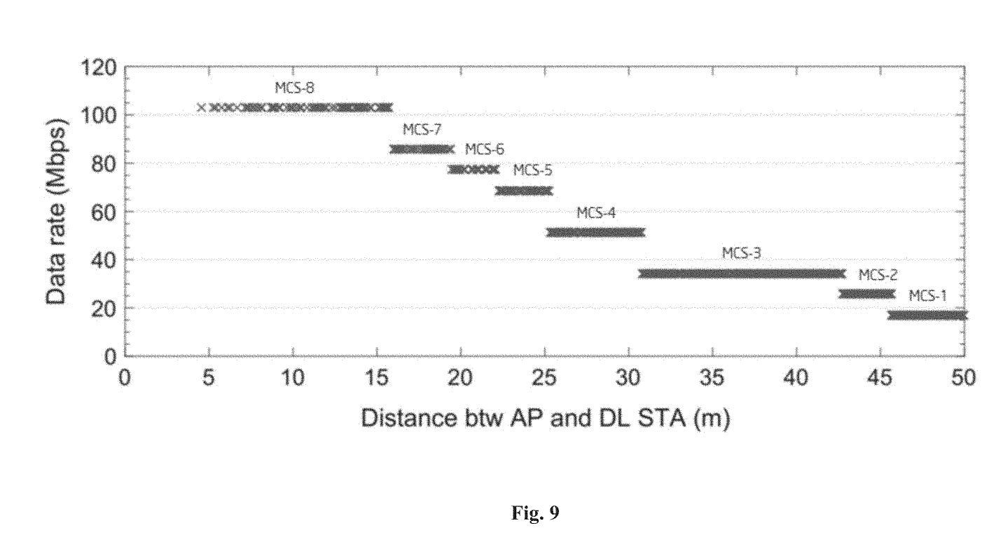

Before delving into the proposed optimization methods, the performance of full-duplex optimization approached discussed above is summarized. In particular, the performance comparison considers the scenario where the DL STA is randomly located within a transmission range from the AP. FIGS. 8-9 show the relation between AP-STA separation, and the MCS used for DL transmission.

It was assumed that UL STAs are randomly selected by the AP as long as their UL transmissions on an OFDMA sub-channel (e.g., 2 MHz) do not degrade the DL throughput performance (i.e., their interference at the DL STA is not significant to require the AP to lower the DL MCS level).

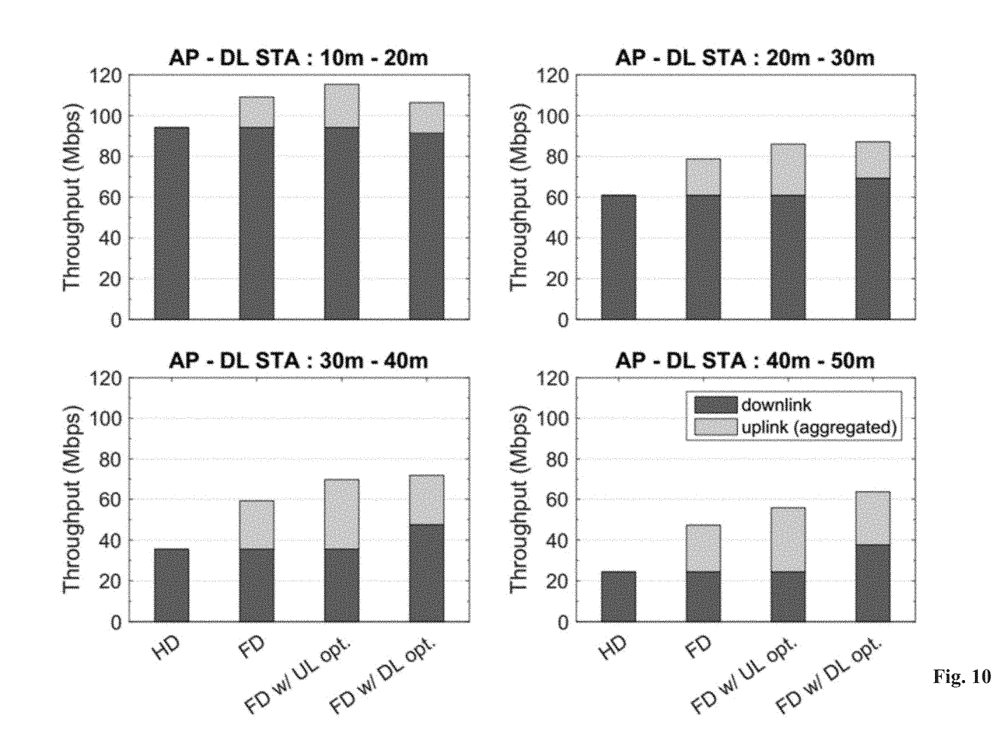

FIG. 10 compares the throughput performance of four transmission modes depending on the level of separation between the AP and DL STA (i.e., 10-20 m, 20-30 m, 30-40 m, and 40-50 m):

Half-duplex (i.e., DL transmission only) (column 1)

Full-duplex without UL/DL optimization (column 2)

Full-duplex with UL transmit power control (column 3)

Full-duplex with DL MCS selection (column 4)

The following observations can be made:

Full-duplex performance gain is higher in general when the DL STA is located far from the AP (e.g., 40-50 m),

DL MCS optimization achieves higher performance gain when the DL STA is located far from the AP.

This is because when a DL STA is located close to the AP, a higher MCS level is used for the DL transmission. Therefore, there is not much room to further improve the DL throughput performance. On the other hand, when the DL STA is located farther from the AP, a lower MCS is used and there is more opportunity to enhance the DL throughput performance by optimally selecting the MCS on each sub-channel based on the interference level cause by UL STAs.

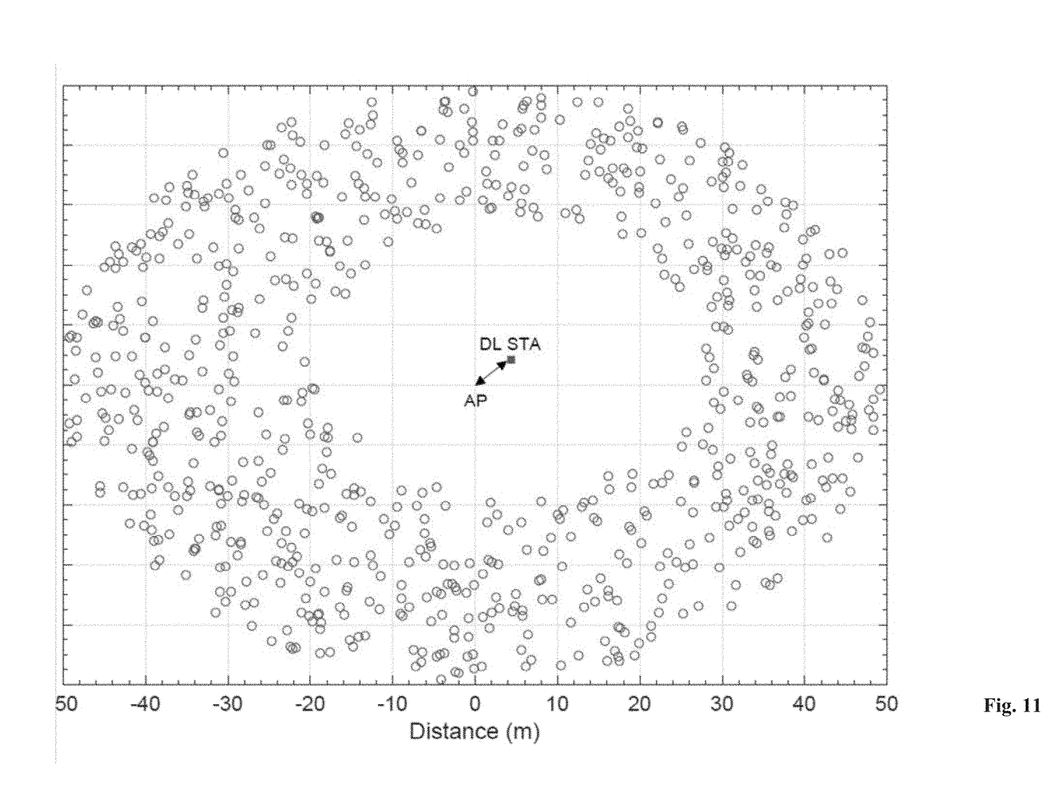

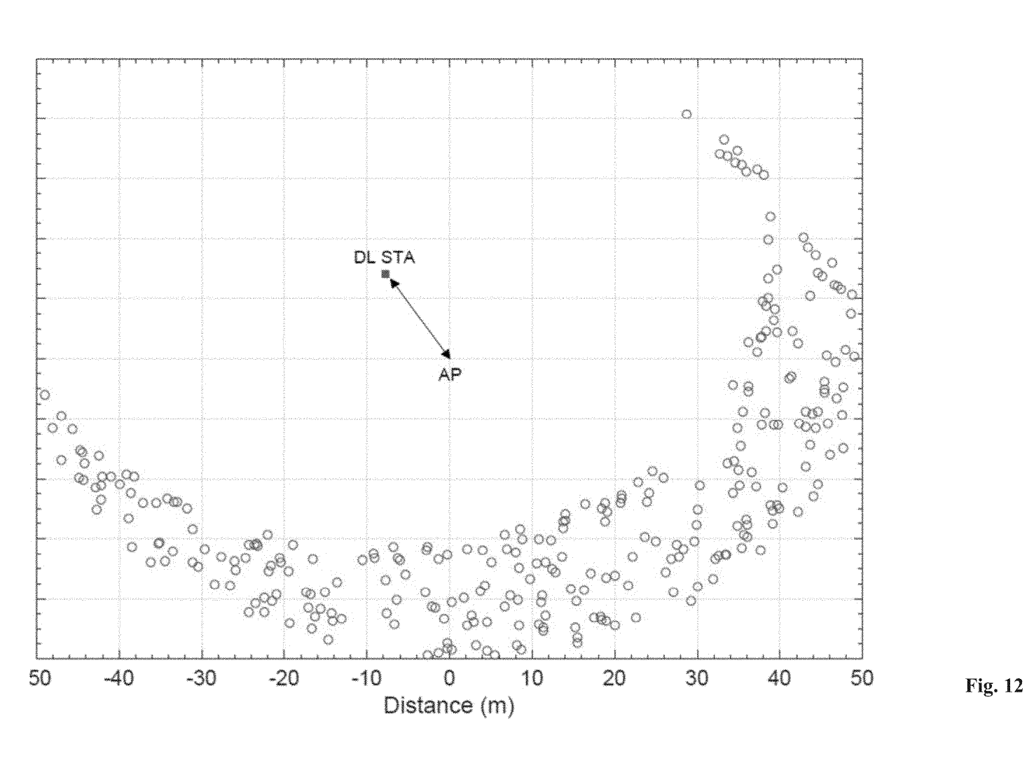

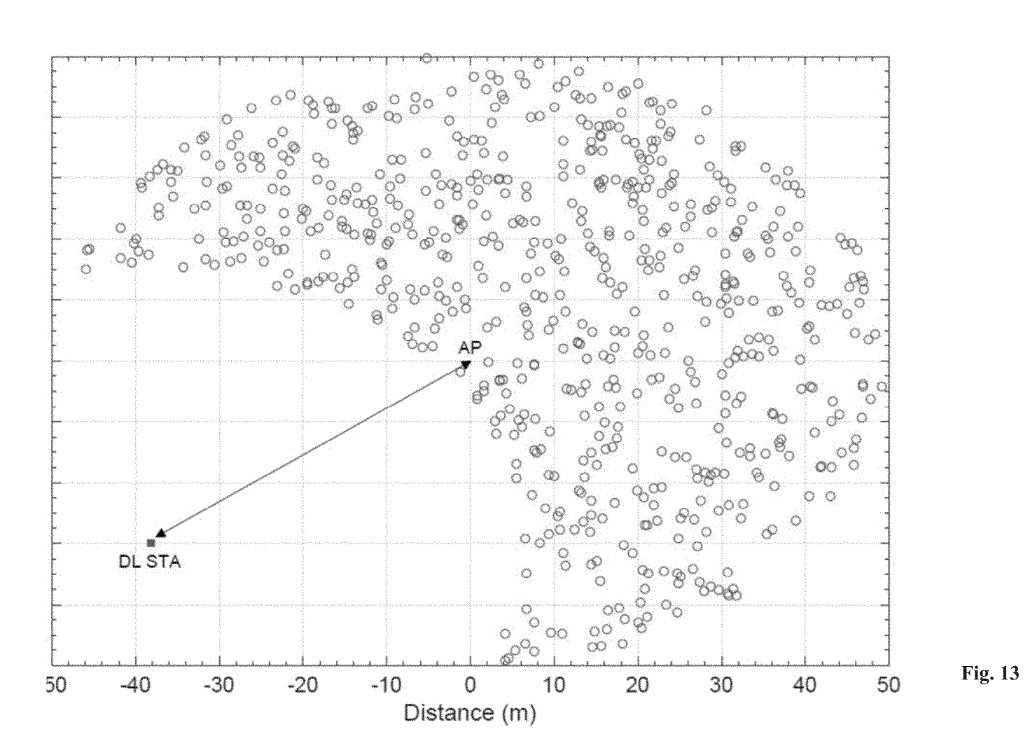

FIGS. 11-13 show the geographical distribution of STAs that are eligible for simultaneous UL OFDMA transmissions without causing performance degradation to the DL performance (i.e., lowering the DL MCS). For example, when the DL STA (denoted as the red square in the figure) is located closer to the AP which is located at the center (0,0) (in FIG. 11), only STAs that are located far from the AP are eligible for simultaneous UL transmissions because the ones that are close to the DL STA will cause a higher level of interference. When the DL STA is located far from the AP (in FIG. 13), only STAs located far from the DL STA can transmit UL frames, but those STAs could be located close to the AP.

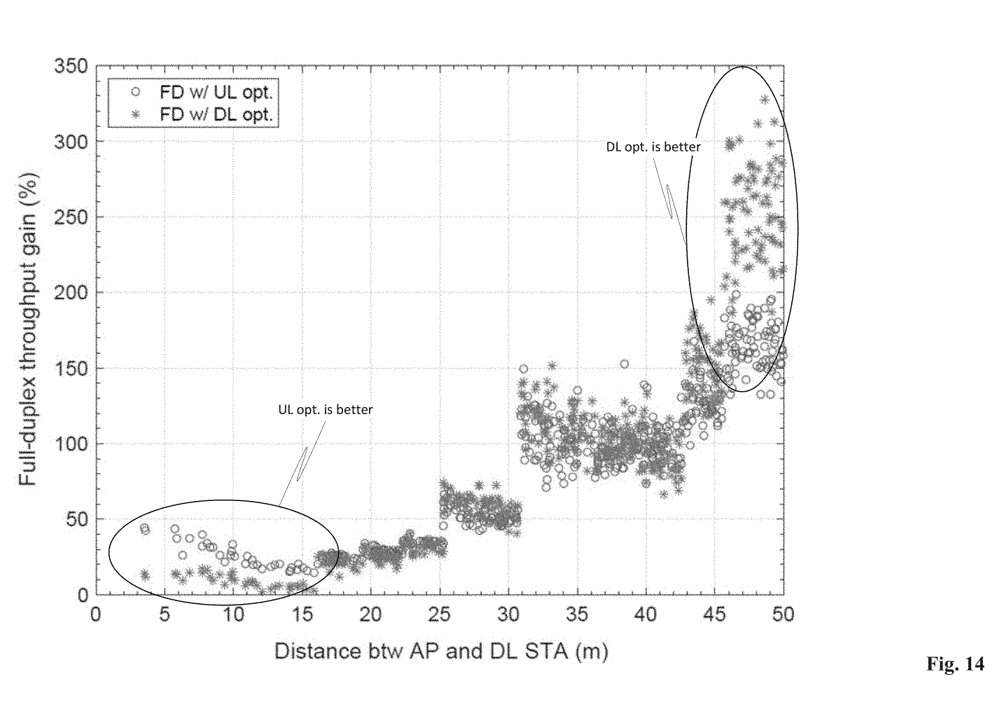

FIG. 14 shows that the DL MCS selection optimization approach achieves higher full-duplex performance gains when the DL STA is located far from the AP, whereas the UL transmit power control optimization achieves better performance when the DL STA is located close to the AP.

Exemplary Behavior of the AP

Motivated by the insights obtained from the simulation study, an exemplary technique uses an adaptive UL vs. DL optimization approach based on the condition of the DL full-duplex link (and/or any other relevant information, e.g., MCS, received signal strength, etc.).

When an AP schedules full-duplex transmissions for simultaneous UL and DL OFDMA transmissions, the AP performs one of the following:

Compares the expected throughput between UL vs. DL optimization
AP calculates the expected throughput performance of both UL and DL optimization approaches as discussed herein, and
AP decides on the optimization approach that maximizes the expected full-duplex OFDMA link throughput performance,
   If it is determined to employ UL optimization, the AP sends the UL transmit power level information for UL STAs in the Full-duplex Trigger Frame,
   If it is determined to employ DL optimization, the AP sends the DL data using OFDMA sub-channels using optimized per-sub-channel MCS.

Performs an UL vs. DL optimization decision based on DL MCS
AP calculates the MCS for the DL transmission based on previous frame exchanges and channel estimation, and
AP compares the DL MCS against pre-defined threshold (e.g., MCS-3)
   If the DL MCS is above the threshold, the AP employs UL optimization; otherwise, the AP employs DL optimization.

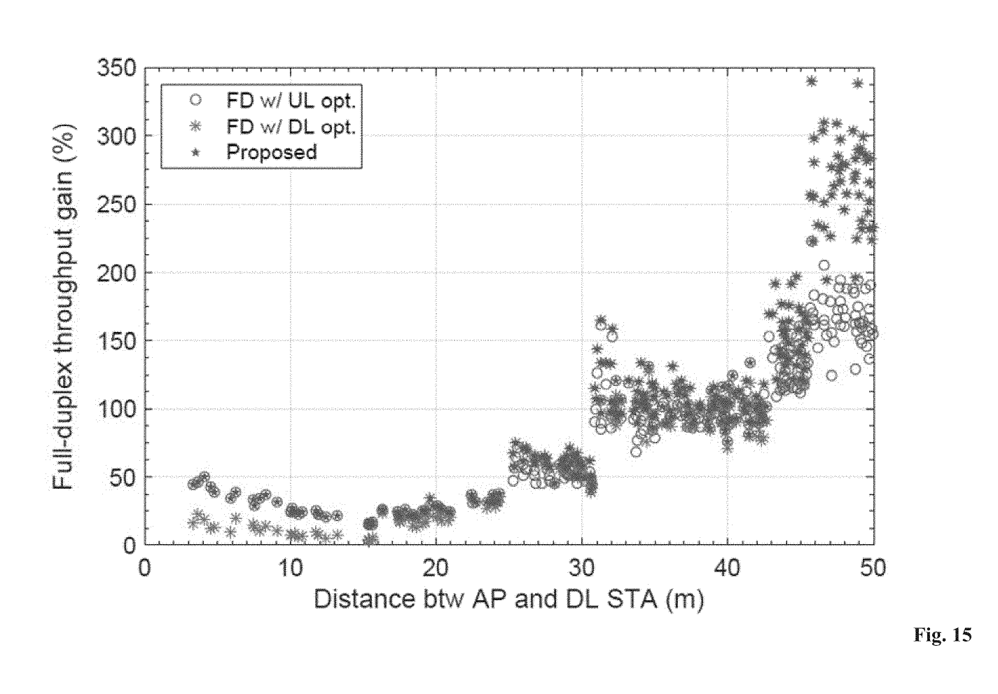

FIG. 15 shows that the proposed adaptive UL and DL optimization approach (denoted as “Proposed” with a “STAR” in the figure) always achieves better performance and outperforms the fixed optimization schemes, thanks to its flexibility in employing the best optimization strategy.

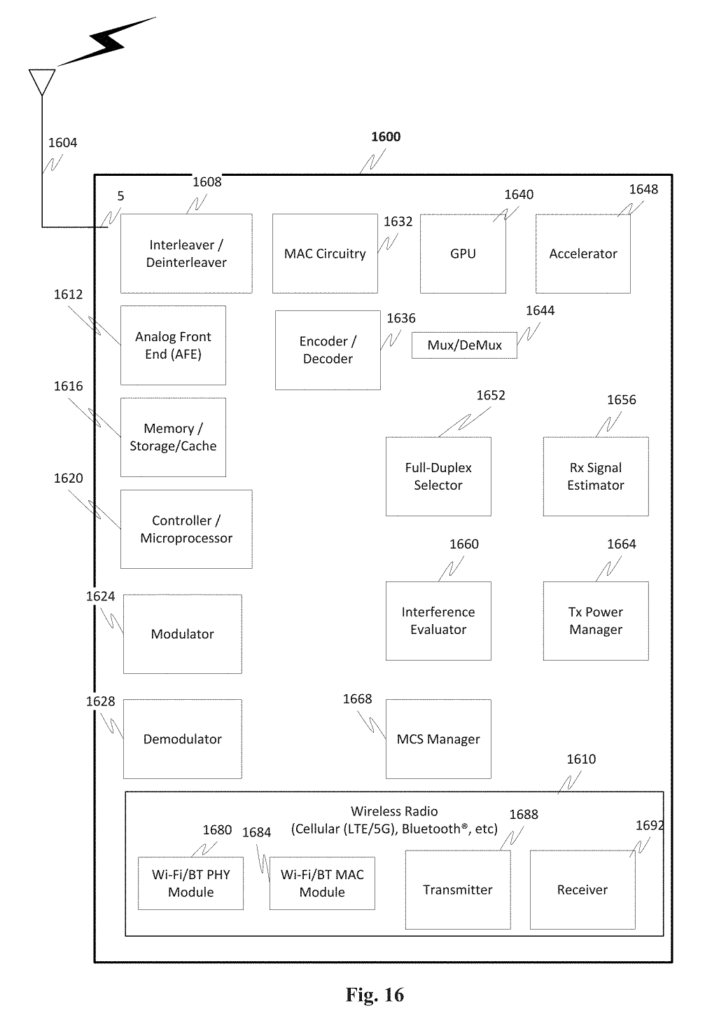

FIG. 16 illustrates an exemplary hardware diagram of a device 1600, such as a wireless device, mobile device, access point (AP), station (STA), or the like, that is adapted to implement the technique(s) discussed herein.

In addition to well-known componentry (which has been omitted for clarity), the device 1600 includes interconnected elements including one or more of: one or more antennas 1604, an interleaver/deinterleaver 1608, an analog front end (AFE) 1612, memory/storage/cache 1616, controller/microprocessor 1620, MAC circuitry 1632, modulator 1624, demodulator 1628, encoder/decoder 1636, GPU 2160, accelerator 1648, a multiplexer/demultiplexer 1644, full-duplex selector 1652, receive signal estimator 1656, interference evaluator 1660, transmit power manager 1664, MCS manager 1668 and wireless radio 1610 components such as a Wi-Fi PHY module/circuit 1680, a Wi-Fi/BT MAC module/circuit 1684, transmitter 1688 and receiver 1692. The various elements in the device 1600 are connected by one or more links/connections (not shown, again for sake of clarity).

The device 1600 can have one more antennas 1604, for use in wireless communications such as Wi-Fi, multi-input multi-output (MIMO) communications, multi-user multi-input multi-output (MU-MIMO) communications Bluetooth®, LTE, 5G, 60 Ghz, WiGig, mmWave systems, etc. The antenna(s) 1604 can include, but are not limited to one or more of directional antennas, omnidirectional antennas, monopoles, patch antennas, loop antennas, microstrip antennas, dipoles, and any other antenna(s) suitable for communication transmission/reception. In one exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users.

Antenna(s) 1604 generally interact with the Analog Front End (AFE) 1612, which is needed to enable the correct processing of the received modulated signal and signal conditioning for a transmitted signal. The AFE 1612 can be functionally located between the antenna and a digital baseband system in order to convert the analog signal into a digital signal for processing, and vice-versa.

The device 1600 can also include a controller/microprocessor 1620 and a memory/storage/cache 1616. The device 1600 can interact with the memory/storage/cache 1616 which may store information and operations necessary for configuring and transmitting or receiving the information described herein. The memory/storage/cache 1616 may also be used in connection with the execution of application programming or instructions by the controller/microprocessor 1620, and for temporary or long term storage of program instructions and/or data. As examples, the memory/storage/cache 1620 may comprise a computer-readable device, RAM, ROM, DRAM, SDRAM, and/or other storage device(s) and media.

The controller/microprocessor 1620 may comprise a general purpose programmable processor or controller for executing application programming or instructions related to the device 1600. Furthermore, the controller/microprocessor 1620 can cooperate with one or more other elements in the device 1600 to perform operations for configuring and transmitting information as described herein. The controller/microprocessor 1620 may include multiple processor cores, and/or implement multiple virtual processors. Optionally, the controller/microprocessor 1620 may include multiple physical processors. By way of example, the controller/microprocessor 1620 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The device 1600 can further include a transmitter 1688 and receiver 1692 which can transmit and receive signals, respectively, to and from other wireless devices and/or access points using the one or more antennas 1604. Included in the device 1600 circuitry is the medium access control or MAC Circuitry 1632. MAC circuitry 1632 provides for controlling access to the wireless medium. In an exemplary embodiment, the MAC circuitry 1632 may be arranged to contend for the wireless medium and configure frames or packets for communicating over the wireless medium.

The device 1600 can also optionally contain a security module (not shown). This security module can contain information regarding but not limited to, security parameters required to connect the device to an access point or other device, or vice versa, or other available network(s), and can include WEP or WPA/WPA-2 (optionally+AES and/or TKIP) security access keys, network keys, etc. As an example, the WEP security access key is a security password used by Wi-Fi networks. Knowledge of this code can enable a wireless device to exchange information with the access point and/or another device. The information exchange can occur through encoded messages with the WEP access code often being chosen by the network administrator. WPA is an added security standard that is also used in conjunction with network connectivity with stronger encryption than WEP.

As shown in FIG. 16, the exemplary device 1600 can also include a GPU 1640, an accelerator 1648, multiplexer/demultiplexer 1644, a Wi-Fi/BT/BLE PHY module 1680 and a Wi-Fi/BT/BLE MAC module 1684 that at least cooperate with one or more of the other components as discussed herein.

In operation, exemplary behavior of a wireless system including two or more devices 1600 (at least one device 1600 being a STA and at least one other device 1600 being an AP), for the above-described non-uniform sub-channel interference in full-duplex OFDMA communication scenarios can be performed as follows.

Adjusting of the Uplink STAs' Transmit Power

Upon the identification of full-duplex opportunity by the full-duplex selector 1652 and selection of downlink and uplink STAs for full-duplex OFDMA, the AP performs the following functions:
A receive signal estimator 1656, optionally at least with processor 1620 and memory 1616, at a downlink STA estimates the received signal strength on each OFDMA sub-channel (or RU) n, denoted as P_{inf,n}, caused by the frame transmissions from UL STAs and reports this information to the AP 1600
The interference evaluator 1660 in the AP, optionally at least with processor 1620 and memory 1616, identifies the maximum interference power, P_{inf,max}, that the downlink STA can tolerate to use an MCS that is the same as (or similar to) the MCS that the downlink STA was using in the half-duplex mode (i.e., in the absence of interference from uplink transmissions)
For each sub-channel n, the transmit power manager 1664 in the AP, optionally at least with processor 1620 and memory 1616, determines the amount of transmit power P_{Δinf,n} that needs to be adjusted (increased/decreased) in dB at the corresponding UL STA without exceeding the maximum interference power P_{inf,max},

P_{Δinf,n}=P_{inf,max}−P_{inf,n} Eq. (1)
The full-duplex selector 1652 of AP with the transmitter 1688 sends a Full-Duplex Trigger frame to the scheduled UL and DL STAs

The Full-Duplex Trigger frame includes the amount of transmit power P_{Δinf,n} that should be adjusted for each UL STA calculated in Eq. (1)
If needed, the AP further adjusts the transmit power level with the transmit power manager 1664 in the AP, optionally at least with processor 1620 and memory 1616, for the UL STAs, e.g., the AP may need to ensure that the received signal strength on OFDMA sub-channels at the AP fall within a certain range
The AP transmits with the transmitter 1688 the DL frame while receiving UL OFDMA frame transmissions on the receiver 1692 from the UL STAs

Adjusting Downlink STA's MCS Per Sub-Channels

As discussed, instead of adjusting transmit power of uplink STAs, the downlink STA may use different MCSs on different sub-channels based on the SINR of each sub-channel. For example:
The downlink STA estimates, using the receive signal estimator 1656, optionally at least with processor 1620 and memory 1616, the received signal strength on each OFDMA sub-channel (or RU) n, denoted as P_{inf,n}, caused by the frame transmissions from UL STAs and reports this information to the AP
The AP calculates an MCS (MCSn) for each sub-channel that can be used in the presence of the interference P_{inf,n}
The AP, using the full-duplex selector 1652 and transmitter 1688, sends a Full-Duplex Trigger frame to the scheduled UL and DL STAs
The AP transmits, using the transmitter 1688, the DL frame while receiving, using the receiver 1692, UL OFDMA frame transmissions from the UL STAs

Exemplary Behavior of the AP

When an AP schedules full-duplex transmissions, using the full-duplex selector 1652, for simultaneous UL and DL OFDMA transmissions, the AP performs one of the following:

i. Compares the expected throughput between UL vs. DL optimization
AP calculates, using the full-duplex selector 1652, optionally at least with processor 1620 and memory 1616, the expected throughput performance of both UL and DL optimization approaches as discussed herein,
AP, using processor 1620 and memory 1616, decides on the optimization approach that maximizes the expected full-duplex OFDMA link throughput performance, and

If it is determined to employ UL optimization, the AP assembles and sends the UL transmit power level information for UL STAs in the Full-duplex Trigger Frame using transmitter 1688

If it is determined to employ DL optimization, the AP sends the DL data using OFDMA sub-channels using an optimized per-sub-channel MCS

ii. Performs an UL vs. DL optimization decision based on DL MCS
AP determines, using the MCS manager 1668, optionally at least with processor 1620 and memory 1616, the MCS for the DL transmission based on previous frame exchanges and channel estimation,
AP compares, using processor 1620 and memory 1616, the DL MCS against pre-defined threshold (e.g., MCS-3), and

If the DL MCS is above the threshold, the AP employs UL optimization;
otherwise, the AP employs DL optimization

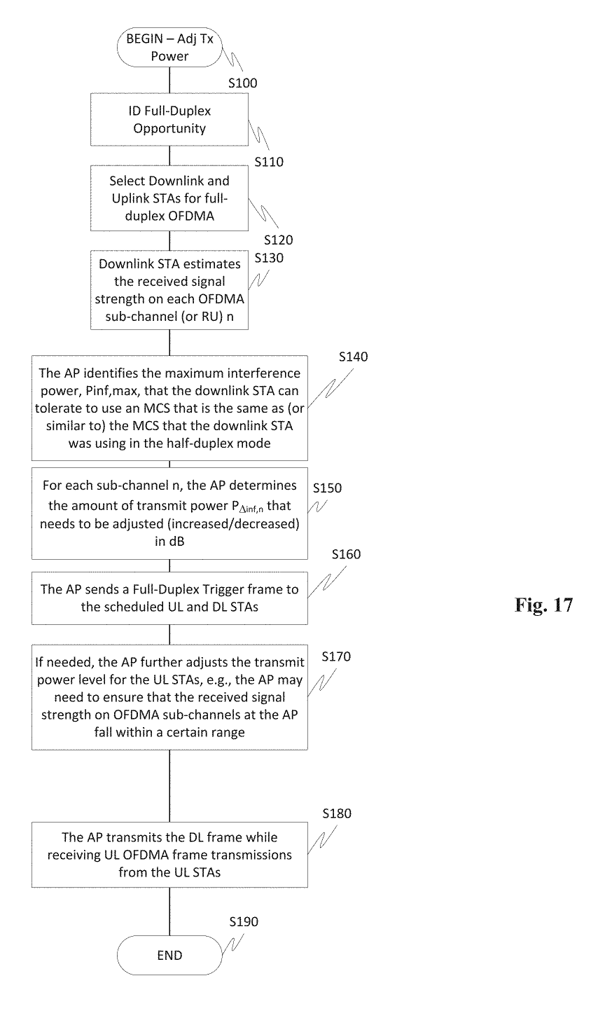

FIG. 17 outlines an exemplary methodology for adjusting of the Uplink STAs' Transmit Power. Control begins in step S100 and continues to step S110. In step S110, and upon the identification of a full-duplex opportunity and selection, in step S120, of downlink and uplink STAs for full-duplex OFDMA, the AP performs the following steps:
In step S130, a downlink STA estimates the received signal strength on each OFDMA sub-channel (or RU) n, denoted as P_{inf,n}, caused by the frame transmissions from UL STAs and reports this information to the AP 1600
In step S140 the AP identifies the maximum interference power, P_{inf,max}, that the downlink STA can tolerate to use an MCS that is the same as (or similar to) the MCS that the downlink STA was using in the half-duplex mode (i.e., in the absence of interference from uplink transmissions)
In step S150, and for each sub-channel n, the AP, determines the amount of transmit power P_{Δinf,n} that needs to be adjusted (increased/decreased) in dB at the corresponding UL STA without exceeding the maximum interference power P_{inf,max},

P_{Δinf,n}=P_{inf,max}−P_{inf,n} Eq. (1)
In step S160, the AP sends a Full-Duplex Trigger frame to the scheduled UL and DL STAs

The Full-Duplex Trigger frame includes the amount of transmit power P_{Δinf,n} that should be adjusted for each UL STA calculated in Eq. (1)
In step S170, and if needed, the AP further adjusts the transmit power level for the UL STAs, e.g., the AP may need to ensure that the received signal strength on OFDMA sub-channels at the AP fall within a certain range
Then, in step S180, the AP transmits the DL frame while receiving UL OFDMA frame transmissions from the UL STAs

Control then continues to step S190 where the control sequence ends.

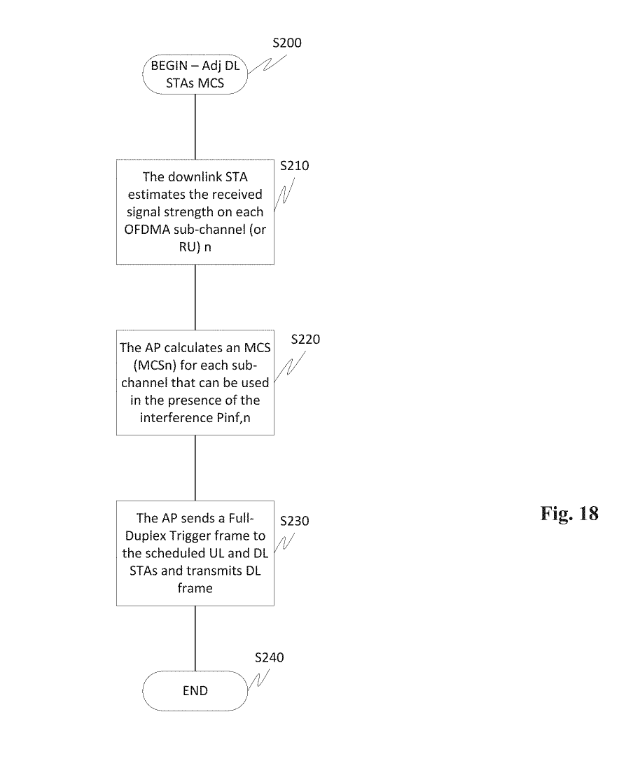

FIG. 18 outlines an exemplary methodology for adjusting the Downlink STA's MCS Per Sub-Channels. Control begins in step S200 and continues to step S210.

As discussed, instead of adjusting transmit power of uplink STAs, the downlink STA may use different MCSs on different sub-channels based on the SINR of each sub-channel. For example:
In step S210, the downlink STA estimates the received signal strength on each OFDMA sub-channel (or RU) n, denoted as P_{inf,n}, caused by the frame transmissions from UL STAs and reports this information to the AP
In step S220, the AP calculates an MCS (MCSn) for each sub-channel that can be used in the presence of the interference P_{inf,n}
In step S230, the AP, sends a Full-Duplex Trigger frame to the scheduled UL and DL STAs and transmits, the DL frame while receiving UL OFDMA frame transmissions from the UL STAs

Control then continues to step S240 where the control sequence ends.

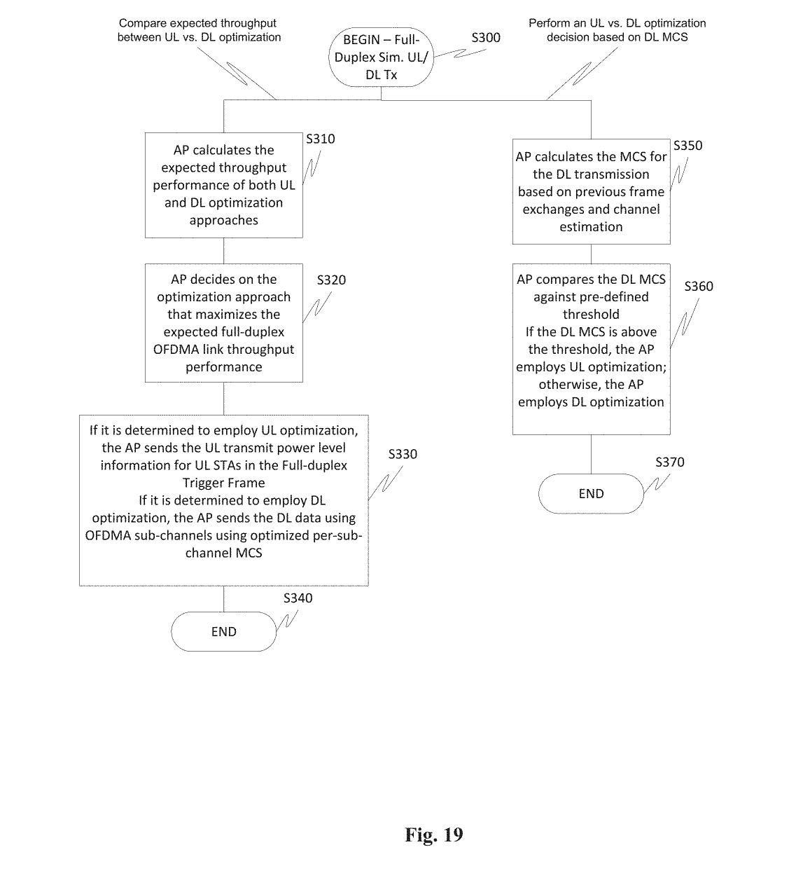

FIG. 19 outlines an exemplary methodology for the operation of an AP with full-duplex simultaneous uplink and downlink transmissions. Control begins in step S100 and continues to step S310 or step S350.

When an AP schedules full-duplex transmissions for simultaneous UL and DL OFDMA transmissions, the AP performs the steps in path S310 or the steps in path S350.

i. Compares the expected throughput between UL vs. DL optimization (Path S310)
In step S310 the AP calculates the expected throughput performance of both UL and DL optimization approaches as discussed herein,
In step S320, the AP decides on the optimization approach that maximizes the expected full-duplex OFDMA link throughput performance, and
In step S330, if it is determined to employ UL optimization, the AP assembles and sends the UL transmit power level information for UL STAs in the Full-duplex Trigger Frame, otherwise,
If it is determined to employ DL optimization, the AP sends the DL data using OFDMA sub-channels using an optimized per-sub-channel MCS

Control then continues to step S340 where the control sequence ends.

ii. Performs an UL vs. DL optimization decision based on DL MCS (Path S350)
In step S350, the AP determines the MCS for the DL transmission based on previous frame exchanges and channel estimation,
In step S360, the AP compares the DL MCS against pre-defined threshold (e.g., MCS-3), and
If the DL MCS is above the threshold, the AP employs UL optimization; otherwise, the AP employs DL optimization

Control then continues to step S370 where the control sequence ends.

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to enhanced GFDM communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:

A wireless communications device comprising:

a full-duplex selector that identifies a full-duplex communication opportunity and selects downlink and uplink stations for the full-duplex communication;
a receive signal estimator that receives a received signal strength estimation from one or more downlink stations;
an interference evaluator connected to a processor and memory that determine a maximum interference power for the one or more downlink stations; and
a transmit power manager that determines an amount of transmit power that needs to be adjusted for each subchannel and adjusts the amount of power.

Any one or more of the above aspects, wherein the interference evaluator, the processor and the memory determine the maximum interference power based on a modulation and coding scheme used in a half-duplex mode.

Any one or more of the above aspects, further comprising a transmitter in communication with the full-duplex selector that sends a full-duplex trigger frame to scheduled uplink and downlink stations.

Any one or more of the above aspects, wherein the transmit power manager further determines an adjusted amount of transmit power.

Any one or more of the above aspects, further comprising a modulation and coding scheme manager that determines a modulation and coding scheme for each subchannel in the presence of interference.

Any one or more of the above aspects, wherein the processor and memory further determine an improved full-duplex link throughput, and send, using a transmitter, uplink transmit power information.

Any one or more of the above aspects, wherein the processor and memory further compares a downlink modulation and coding scheme (DL MCS) against a pre-defined threshold, and when the DL MCS is above the threshold, the wireless communications device employs uplink optimization, otherwise, the wireless communications device employs downlink optimization.

Any one or more of the above aspects, further comprising one or more connected elements including a receiver, an interleaver/deinterleaver, an analog front end, a GPU, an accelerator, an encoder/decoder, one or more antennas, a processor and memory.

A non-transitory information storage media having stored thereon one or more instructions, that when executed by one or more processors, cause a wireless communications device to perform a method comprising:
identifying a full-duplex communication opportunity and selecting downlink and uplink stations for the full-duplex communication;
receiving a received signal strength estimation from one or more downlink stations;
determining a maximum interference power for the one or more downlink stations; and
determining an amount of transmit power that needs to be adjusted for each subchannel and adjusting the amount of transmit power.

Any one or more of the above aspects, further comprising determining the maximum interference power based on a modulation and coding scheme used in a half-duplex mode.

Any one or more of the above aspects, further comprising sending a full-duplex trigger frame to scheduled uplink and downlink stations.

Any one or more of the above aspects, further comprising determining an adjusted amount of transmit power.

Any one or more of the above aspects, further comprising determining a modulation and coding scheme for each subchannel in the presence of interference.

Any one or more of the above aspects, further comprising determining an improved full-duplex link throughput, and sending uplink transmit power information.

Any one or more of the above aspects, further comprising comparing a downlink modulation and coding scheme (DL MCS) against a pre-defined threshold, and when the DL MCS is above the threshold, employing uplink optimization, otherwise, employing downlink optimization.

A wireless communications device comprising:
means for identifying a full-duplex communication opportunity and means for selecting downlink and uplink stations for the full-duplex communication;
means for receiving a received signal strength estimation from one or more downlink stations;
means for determining a maximum interference power for the one or more downlink stations; and
means for determining an amount of transmit power that needs to be adjusted for each subchannel and adjusting the amount of transmit power.

Any one or more of the above aspects, further comprising means for determining the maximum interference power based on a modulation and coding scheme used in a half-duplex mode.

Any one or more of the above aspects, further comprising means for sending a full-duplex trigger frame to scheduled uplink and downlink stations.

Any one or more of the above aspects, further comprising means for determining an adjusted amount of transmit power.

Any one or more of the above aspects, further comprising means for determining a modulation and coding scheme for each subchannel in the presence of interference.

Any one or more of the above aspects, further comprising means for determining an improved full-duplex link throughput, and sending uplink transmit power information.

Any one or more of the above aspects, further comprising means for comparing a downlink modulation and coding scheme (DL MCS) against a pre-defined threshold, and when the DL MCS is above the threshold, employing uplink optimization, otherwise, employing downlink optimization.

A method for operating a wireless communications device comprising:
identifying a full-duplex communication opportunity and means for selecting downlink and uplink stations for the full-duplex communication;
receiving a received signal strength estimation from one or more downlink stations;
determining a maximum interference power for the one or more downlink stations; and
determining an amount of transmit power that needs to be adjusted for each subchannel and adjusting the amount of transmit power.

Any one or more of the above aspects, further comprising determining the maximum interference power based on a modulation and coding scheme used in a half-duplex mode.

Any one or more of the above aspects, further comprising sending a full-duplex trigger frame to scheduled uplink and downlink stations.

Any one or more of the above aspects, further comprising determining an adjusted amount of transmit power.

Any one or more of the above aspects, further comprising determining a modulation and coding scheme for each subchannel in the presence of interference.

Any one or more of the above aspects, further comprising determining an improved full-duplex link throughput, and sending, using a transmitter, uplink transmit power information.

Any one or more of the above aspects, further comprising comparing a downlink modulation and coding scheme (DL MCS) against a pre-defined threshold, and when the DL MCS is above the threshold, using uplink optimization, otherwise, the using downlink optimization.

A system on a chip (SoC) including any one or more of the above aspects.

One or more means for performing any one or more of the above aspects.

Any one or more of the aspects as substantially described herein.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, Wi-Fi, LTE, 4G, Bluetooth®, WirelessHD, WiGig, WiGi, 3GPP, Wireless LAN, WiMAX, and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has at least been provided systems and methods for enhanced GFDM communications. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A wireless communications device comprising:
a full-duplex selector that identifies a full-duplex communication opportunity and selects downlink and uplink stations for the full-duplex communication;
a receive signal estimator that receives a received signal strength estimation from one or more downlink stations;
an interference evaluator connected to a processor and memory that determine a maximum interference power for the one or more downlink stations; and
a transmit power manager that determines an amount of transmit power that needs to be adjusted for each subchannel and adjusts the amount of power.

2. The wireless communications device of claim 1, wherein the interference evaluator, the processor and the memory determine the maximum interference power based on a modulation and coding scheme used in a half-duplex mode.

3. The wireless communications device of claim 1, further comprising a transmitter in communication with the full-duplex selector that sends a full-duplex trigger frame to scheduled uplink and downlink stations.

4. The wireless communications device of claim 1, wherein the transmit power manager further determines an adjusted amount of transmit power.

5. The wireless communications device of claim 1, further comprising a modulation and coding scheme manager that determines a modulation and coding scheme for each subchannel in the presence of interference.

6. The wireless communications device of claim 1, wherein the processor and memory further determine an improved full-duplex link throughput, and send, using a transmitter, uplink transmit power information.

7. The wireless communications device of claim 1, wherein the processor and memory further compares a downlink modulation and coding scheme (DL MCS) against a pre-defined threshold, and when the DL MCS is above the threshold, the wireless communications device employs uplink optimization, otherwise, the wireless communications device employs downlink optimization.

8. The wireless communications device of claim 1, further comprising one or more connected elements including a receiver, an interleaver/deinterleaver, an analog front end, a GPU, an accelerator, an encoder/decoder, one or more antennas, a processor and memory.

9. A non-transitory information storage media having stored thereon one or more instructions, that when executed by one or more processors, cause a wireless communications device to perform a method comprising:
identifying a full-duplex communication opportunity and selecting downlink and uplink stations for the full-duplex communication;
receiving a received signal strength estimation from one or more downlink stations;
determining a maximum interference power for the one or more downlink stations; and
determining an amount of transmit power that needs to be adjusted for each subchannel and adjusting the amount of transmit power.

10. The storage media of claim 9, further comprising determining the maximum interference power based on a modulation and coding scheme used in a half-duplex mode.

11. The storage media of claim 9, further comprising sending a full-duplex trigger frame to scheduled uplink and downlink stations.

12. The storage media of claim 9, further comprising determining an adjusted amount of transmit power.

13. The storage media of claim 9, further comprising determining a modulation and coding scheme for each subchannel in the presence of interference.

14. The storage media of claim 9, further comprising determining an improved full-duplex link throughput, and sending uplink transmit power information.

15. The storage media of claim 9, further comprising comparing a downlink modulation and coding scheme (DL MCS) against a pre-defined threshold, and when the DL MCS is above the threshold, employing uplink optimization, otherwise, employing downlink optimization.

16. A wireless communications device comprising:
means for identifying a full-duplex communication opportunity and means for selecting downlink and uplink stations for the full-duplex communication;
means for receiving a received signal strength estimation from one or more downlink stations;
means for determining a maximum interference power for the one or more downlink stations; and
means for determining an amount of transmit power that needs to be adjusted for each subchannel and adjusting the amount of transmit power.

17. The wireless communications device of claim 16, further comprising means for determining the maximum interference power based on a modulation and coding scheme used in a half-duplex mode.

18. The wireless communications device of claim 16, further comprising means for sending a full-duplex trigger frame to scheduled uplink and downlink stations.

19. The wireless communications device of claim 16, further comprising means for determining an adjusted amount of transmit power.

20. The wireless communications device of claim 16, further comprising means for determining a modulation and coding scheme for each subchannel in the presence of interference.

21. The wireless communications device of claim 16, further comprising means for determining an improved full-duplex link throughput, and sending uplink transmit power information.

22. The wireless communications device of claim 16, further comprising means for comparing a downlink modulation and coding scheme (DL MCS) against a pre-defined threshold, and when the DL MCS is above the threshold, employing uplink optimization, otherwise, employing downlink optimization.

23. A method for operating a wireless communications device comprising:
identifying a full-duplex communication opportunity and means for selecting downlink and uplink stations for the full-duplex communication;
receiving a received signal strength estimation from one or more downlink stations;
determining a maximum interference power for the one or more downlink stations; and
determining an amount of transmit power that needs to be adjusted for each subchannel and adjusting the amount of transmit power.
